(19) United States
(12) Patent Application Publication
(10) Pub. No.: US 2015/0259980 A1
(43) Pub. Date: Sep. 17, 2015

(54) STEPLADDER WITH TOOL CARRIER

(71) Applicant: UNIVERSALTOOLBOX UG (HAFTUNGSBESCHRÄNKT), Mannheim (DE)

(72) Inventors: Mats Johansen, Mannheim (DE); Peter Schumacher, Mannheim (DE); Erik Moser, Schonau (DE); Felix Fabian, Mannheim (DE)

(21) Appl. No.: 14/432,136

(22) PCT Filed: Sep. 30, 2013
(86) PCT No.: PCT/EP2013/070310

§ 371 Date: Mar. 27, 2015

(30) Foreign Application Priority Data
Sep. 28, 2012 (DE) 10 2012 217 857.0

(51) Int. Cl. E06C 1/38

(52) U.S. Cl. CPC E06C 1/38

(57) ABSTRACT

A stepladder which is placed on a tool carrier and which is folded up when in the transport position with the handle extracted, has a folding step which in this position is flush with the side wall of the ladder part. The stepladder surrounds the tool carrier above the level of a base.

### TECHNICAL FIELD

The invention relates to a step ladder comprising a tool carrier. The tool carrier serves to accommodate and carry tools, which step ladder is adapted for increasing the working height, e.g. on a building site, in a workshop, or in an assembly hall, but also in private households.

### PRIOR ART

A tool box comprising a stool is disclosed in DE 296 09 524 U1, in which the stool is lowered over a drawer cabinet, by which means the drawers are held in a closed position.

A step ladder in the form of a stable, hollow box is disclosed in DE 2 127 666 A1, in which the top step forms a lid for a container situated beneath it.

A multi-purpose step ladder is disclosed in DE 81 33 640 U1, in which tool bags can be attached inside the tubular frame of said ladder.

It is an object of the present invention to further develop a step ladder in such a way that the tool carrier is fully closed when the step ladder has been fitted thereon such that accidental opening of the step ladder is prevented and that a collapsible step ladder is provided that is sufficiently stable to fulfill the requirements of official authorities or the standards for step ladders in general.

### DESCRIPTION OF THE INVENTION

The step ladder of the invention comprising a tool carrier consists of two ladder parts comprising a top step, the two ladder parts being foldably connected by means of a hinge in the region of the top step.

At least one ladder part comprises a folding step pivotally disposed about a bearing between lateral uprights of the ladder part, said folding step being movable in the direction of the uprights of the ladder part when the step ladder is in a collapsed position, and to a position extending toward the other ladder part parallel to the top step when the step ladder is in an opened position. The tool carrier comprises a base and at least one tool carrier wall that is disposed thereon and extends away from the base and is adapted to be enclosed by the ladder parts. The tool carrier wall comprises a guide surface and/or a guide point for the folding step, disposed on a side facing away from the base, which guide surface and/or guide point interacts with the folding step and guides the folding step from the opened position parallel to the top step to the position in the direction of the uprights when the ladder part comprising the folding step is lowered onto the tool carrier from above. A hinged strut possessing high compressive and tensile rigidity is provided on the folding step at a distance from the bearing, is rotatably joined to the opposing ladder part, and has a length and bearing points that are dimensioned such that the ladder parts can be moved from the opened position to the collapsed position and vice versa when the folding step is being pivoted.

Therefore, in the collapsed position, a tool box is created consisting of the step ladder and the tool carrier, for ease of transport. In the opened position, the step ladder and the tool carrier represent two separate pieces of equipment that can be used individually. Since the ladder parts collapse automatically and the folding steps fold down when being mounted onto the tool carrier, all openings are covered and the tool box is closed to the environment.

It is advantageous when each ladder part comprises a single step. In this case it is possible to ascend the step ladder on either side and a safety bar is not required, as may be the case with single-sided ladders.

It is advantageous when the tool carrier wall is eccentrically disposed on the base by means of the guide surface and/or guide point, and when an inner wall comprises a more centrally disposed inner guide surface or inner guide point. The inner guide surface or inner guide point may be disposed above the guide surface or the guide point of the tool carrier wall. Thus subdivision of the path of movement is possible, and the different positions of the ladder parts relatively to each other can be accommodated in a simple manner.

It is advantageous when the guide surface of the tool carrier wall is at an angle of from 35 to 60 degrees, preferably 45 degrees, and when the guide surface of the inner wall is at an angle of from 10 to 30 degrees, preferably from 15 to 20 degrees. For practical purposes, within said range of angles the geometric ratios are sufficiently well accounted for the purpose of effecting secure closing.

It is advantageous when the ladder part comprises a closed wall section below the folding step and the side wall of the ladder part is completely closed when in the collapsed position.

It is advantageous when the tool carrier has a handle on the side facing away from the base, which handle is guided longitudinally displaceably along a sliding rail on the inner wall and/or on the tool carrier wall and is transversely tiltable relatively to the sliding rail in an upper position. As a result, the tool carrier is able to hold tools in its central region.

It is advantageous when the step ladder has a recess for the handle in the top step in the region of the hinge, the handle being guarded against tilting by means of contact surfaces on the top step when the step ladder is mounted. This facilitates transportation and handling of the tool box.

It is advantageous when the handle is entirely retractable when the step ladder is mounted, resulting in it being flush with the surface of the step. The space required to store the tool box is thus minimized.

It is advantageous when the base has a groove for the purpose of receiving and laterally retaining the ladder part on at least two opposing edges by means of a bottom wall section entering the groove. This prevents spreading of the ladder parts when the ladder is mounted.

It is advantageous when the ladder part comprising the folding step comprises a support on the inner side of the upright on which the folding step rests in the opened position. Stabilization is thereby achieved and the opening angle further restricted.

It is advantageous when the strut on the ladder parts is in each case attached below the bearing of the folding step so that, when the step ladder is in an opened position, the strut assumes an angle of from 5 to 45 degrees, preferably from 15 to 20 degrees. Such an arrangement of the strut facilitates smooth opening and closing of the ladder during everyday use.

### BRIEF DESCRIPTION OF THE DRAWINGS

The invention is explained below with reference to the drawings, in which:

FIG. 1 shows a step ladder 1 for mounting on a tool carrier in an upper position;

FIG. 2 shows the step ladder of FIG. 1 lowered over the tool carrier 2 to assume a lower position;

FIG. 3 shows the step ladder of FIGS. 1 and 2 with the ladder parts fully closed;

FIG. 4 shows the tool carrier as viewed from above;

FIG. 5 is a side view of the tool carrier;

FIG. 6 illustrates the forced coupling of the ladder parts and the folding steps;

FIG. 7 is a diagrammatic view of the collapsed step ladder;

FIG. 8 shows supports for varying and supporting the opened folding steps;

FIG. 9 shows the ladder part comprising the step and the folding step resting on a support;

FIG. 10 shows a handle mounted on the inner wall in a first, rotated position;

FIG. 11 shows the handle of FIG. 10 in a partly recessed, second position;

FIG. 12 is a perspective view of the folded step ladder mounted on the tool carrier.

### EXEMPLARY EMBODIMENT

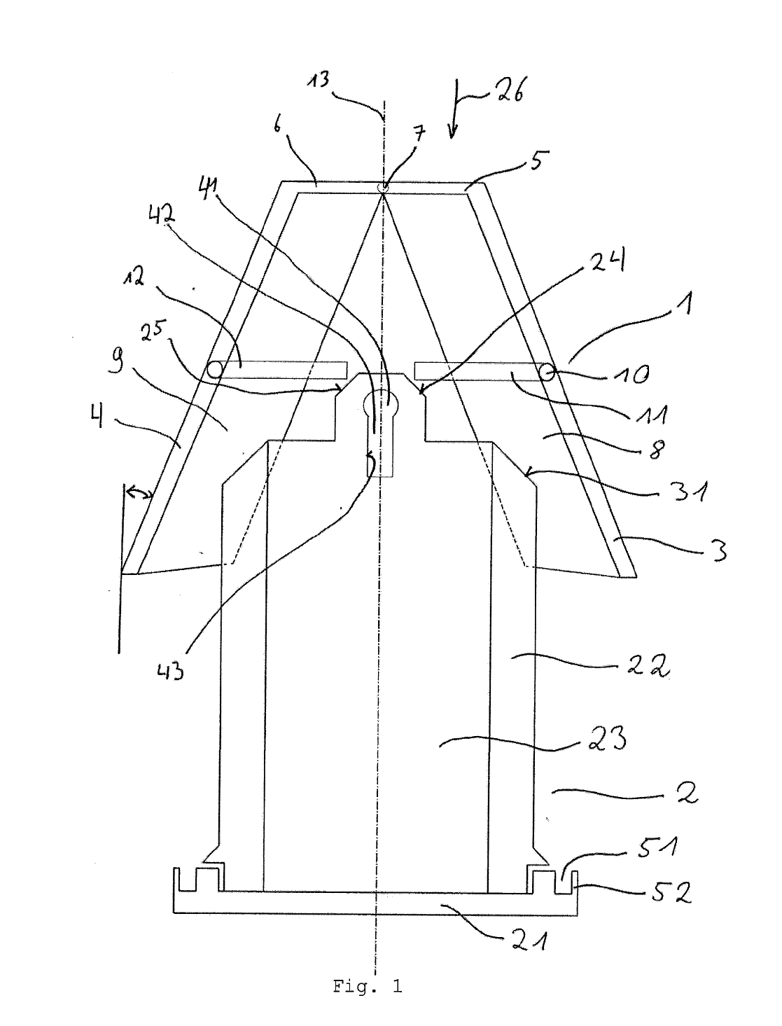

FIG. 1 shows a step ladder 1 for mounting on a tool carrier 2, said step ladder comprising two ladder parts 3, 4 each comprising a top step 5, 6, which two ladder parts are interconnected by means of a hinge 7 and are adapted to close toward, or open away from, each other. Each ladder part 3, 4 comprises a folding step 11, 12 pivotally disposed about a bearing 10 between the lateral rails 8, 9 of the ladder parts 3, 4, said folding step being in the opened position of the step ladder 1 as shown, parallel to the top step 5, 6 and thus extending toward the other ladder part 3, 4.

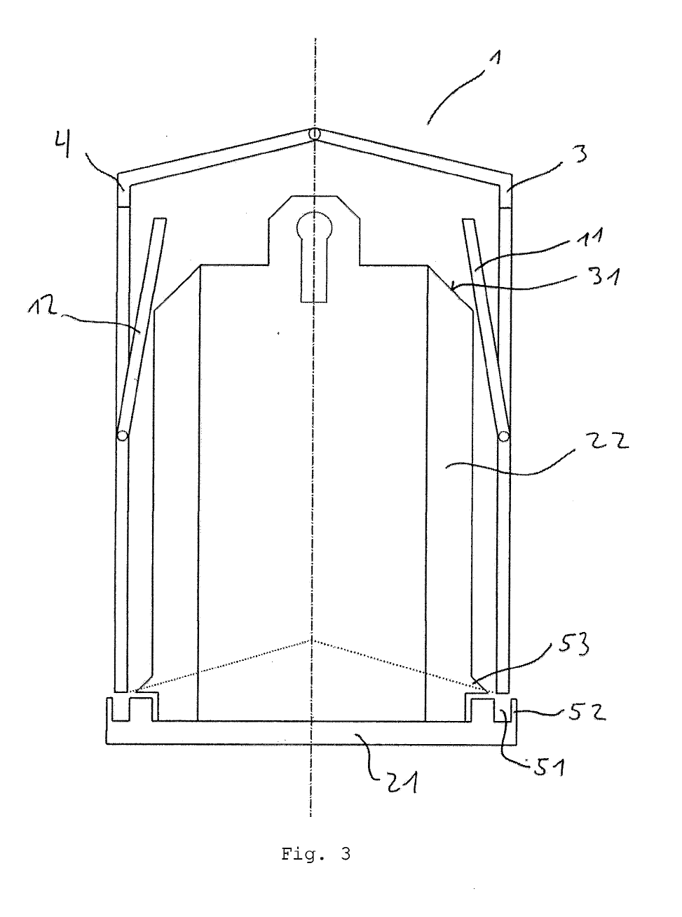

The step ladder 1 is symmetrically constructed about a central axis 13, the hinge 7 being disposed on said central axis 13. The tool carrier 2 comprises a base 21 and a tool carrier wall 22 disposed on, and extending away from, said base 21, said tool carrier wall being laterally enclosed by the ladder parts 3, 4 when the ladder is mounted as illustrated in FIG. 3 and described below with reference thereto.

The tool carrier wall 22 is eccentrically disposed on the base 21, that is to say, at a distance from the central axis 13, and an inner wall 23 is provided at a shorter distance from the central axis 13. The inner wall 23 comprises a guide surface 24, 25 on its upper side facing away from the base 2, which guide surface slopes outwardly, that is to say, away from the central axis 13, and is adapted to interact with the folding step 11, 12 when the opened step ladder is mounted on the tool carrier 2 from above.

Instead of the outwardly and downwardly sloping guide surface 24, 25, a guide point or support point may be used, upon which the folding step 11, 12 initially rests when the step ladder 1 is mounted and along which it glides when the step ladder 1 is lowered. However, the use of a guide surface 24, 25 has the advantage over a guide point (not shown) that a defined support having a larger flat surface may be created, at least for a single, intermediate position. However, this is not absolutely necessary.

In the upper position of the step ladder 1 in relation to the tool carrier 2, as shown in FIG. 1, the folding steps 11, 12 still rest against the guide surfaces 24, 25 of the inner wall 23, and the step ladder is still shown in a maximally opened position, the angle shown at this point being 15 degrees per ladder part, that is to say, 30 degrees in all.

The direction of movement of the step ladder 1 and the tool carrier 2 in relation to each other is indicated by the arrow 26 oriented along the central axis 13.

In addition to the guide surfaces 24, 25 on the inner wall 23, the tool carrier wall 22 also comprises a guide surface 31 disposed below the guide surface 24 of the inner wall 23, that is to say, closer to the base 21 and at a more outward position. The guide surface 31 is at a more acute angle than the guide surface 24, but also slopes outwardly and downwardly. The function of the guide surface 31 on the tool carrier wall 22 is explained below in detail with reference to the figures.

FIG. 1 further shows a circular recess 41 communicating with an elongated sliding rail 43 formed by a further recess 42. Said recesses 41, 42 serve to accommodate a handle (not shown) and to enable tilting thereof to an upper position and to enable the insertion and fixation of the handle to prevent it from tilting in the region of the sliding rail 43.

The base 21 has a locating slot 51 disposed near its outer edge 52. Said slot serves to receive and secure the ladder part 3 when the closed step ladder 1 is totally fitted over the tool carrier 2.

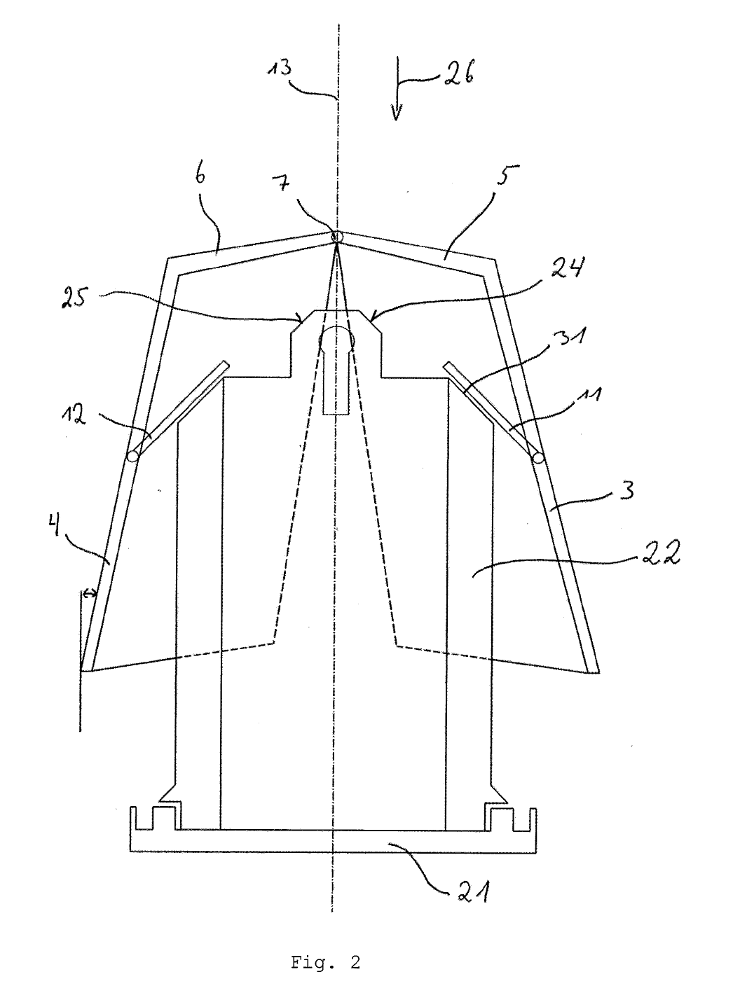

FIG. 2 shows how the step ladder 1 is further lowered toward the base 21 in the direction of the arrow 26, in order to be fitted over the tool carrier 2. To this end, the folding steps 11, 12 have been guided entirely past the guide surfaces 24, 25 to rest on the guide surface 31 of the tool carrier wall 22. The two ladder parts 3, 4 have moved toward one another and the opening angle of the step ladder 1 has decreased due to a forced coupling of the two ladder parts 3, 4 with the folding step 11, 12 (shown and explained below with reference to FIG. 6), that is to say, the step ladder has incipiently closed around the central axis 13. In this position, the steps 5, 6 have also approached one another around the joint 7.

FIG. 3 shows the step ladder 1 in the fully collapsed position of the ladder parts 3, 4 prior to reaching the final position, complete closure being effected by further lowering of the unit toward the base 21. The folding steps 11, 12 have been fully raised, at least approximately, by sliding along the guide surface 31 and thus lie in the plane of the outer surfaces of the ladder parts 3, 4. The lower edge of the ladder parts 3, 4 is close to being docked in the locating slot 51 disposed at the outer edge 52 of the base 21. When the closed step ladder 1 is completely fitted over the tool carrier 2, the ladder parts 3, 4 are accommodated and secured in said slot 51. For the purpose of facilitating the docking action, outward protrusions 53 are formed on the tool carrier wall 22 that act as glide slopes and guide the lower edge of the ladder parts 3, 4 prior to their reaching the final position.

FIG. 4 shows the tool carrier 2 as viewed from above and illustrates the base 21 comprising the edge 51 and the groove 52 contained therein, the edge 51 being only required on two oppositely disposed sides of the base. The tool carrier wall 22 is disposed on the base 21 in a central region around the central axis (not shown), allowing a view of the guide surface 31. Such a tool carrier wall 22 is basically sufficient, but two oppositely disposed tool carrier walls are provided for the purpose of increasing the storage capacity to allow for the tidy storage of tools. The inner wall 23 is disposed between the two tool carrier walls, the guide surfaces 24, 25 being located on the upper surface of the inner wall, facing the viewer.

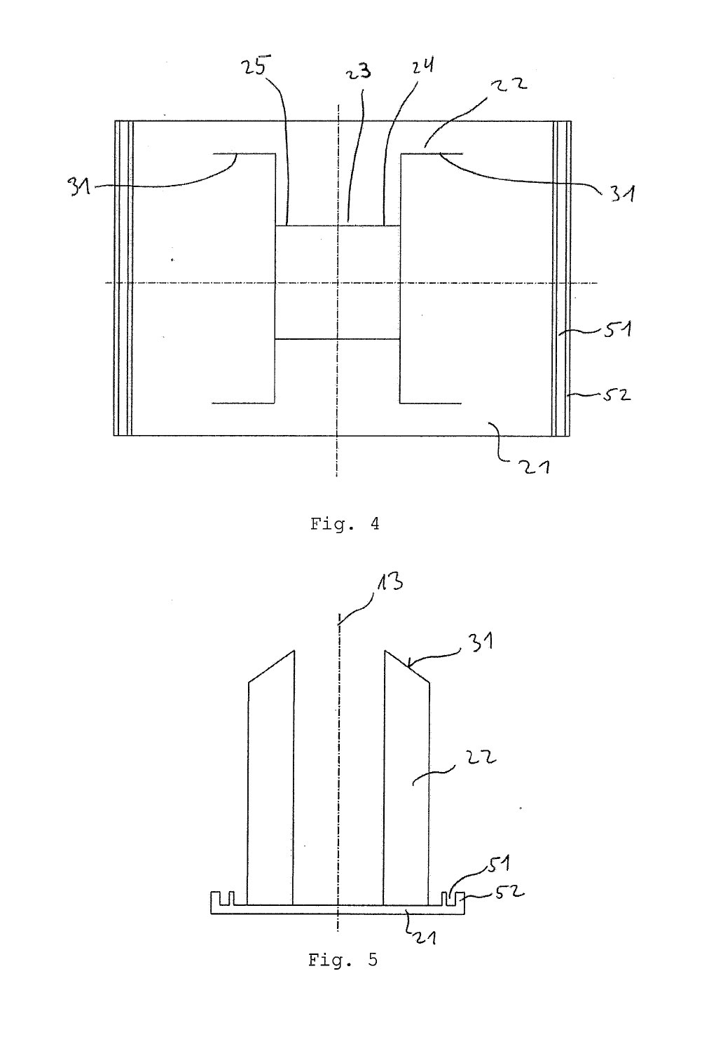

FIG. 5 shows the tool carrier 2 in a side view not including the step ladder nor the inner surfaces. The guide surfaces 31 disposed on each of the oppositely disposed tool carrier walls 22 on either side of the central axis 13 are shown, as is the base 21 having the edge 52 and the groove 51 contained therein. This embodiment is sufficient to enable raising of the folding steps 30 when the step ladder is being mounted.

FIG. 6 illustrates the forced coupling of the ladder parts 3, 4 and the folding steps 11, 12. A hinged strut 61, 62 possessing high compressive and tensile rigidity is provided on each of the folding steps 11, 12 at a distance from the bearing 10, rotatably joined to the oppositely disposed ladder parts 4, 3, the length 1 of which and the bearing points 63, 64 in the ladder part 3, 4 being dimensioned such that the ladder parts 3, 4 can be moved from the opened position to the collapsed position, and vice versa, by swiveling the folding step 11, 12.

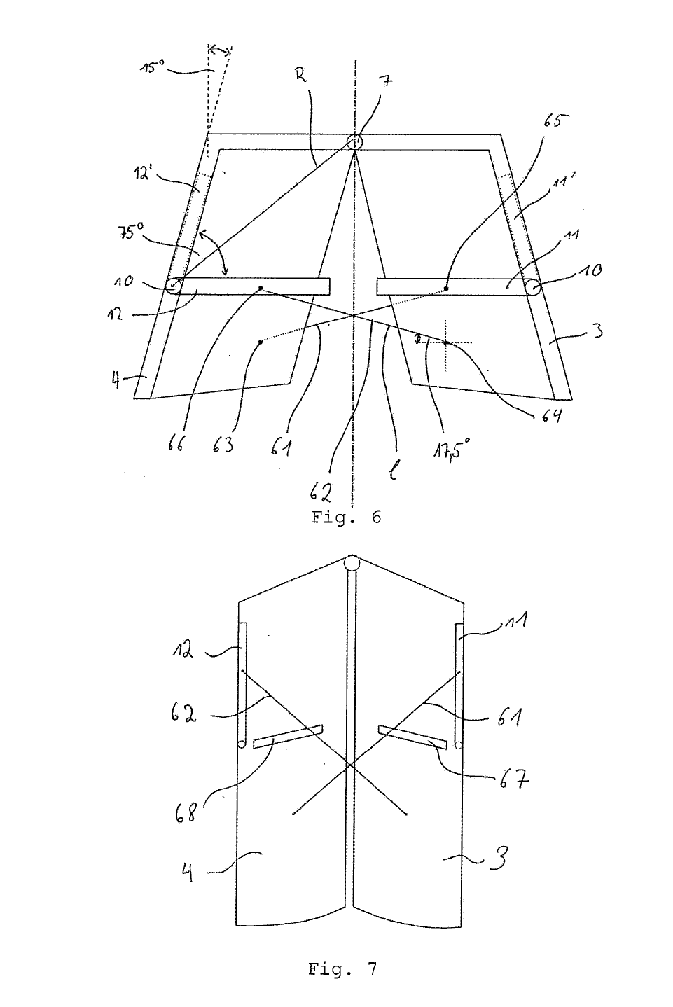

The distance of the bearing of the folding step 11, 12 from the hinge 7 connecting the two ladder parts 3, 4 is identified as radius R. The strut 61, 62 is fixed to the bearing points 65, 66 in the folding steps 11, 12. If one of the folding steps 11, 12 is moved about the hinge 10 from the opened position (as shown) of the step ladder to the position identified by dashed lines, indicated as 11′, 12′ (shown in FIG. 7 below), the process of raising the folding step 11, 12 enables a pulling force to be applied to the strut, causing the opposing ladder part to move toward the ladder part accommodating the folding step, thus closing the step ladder.

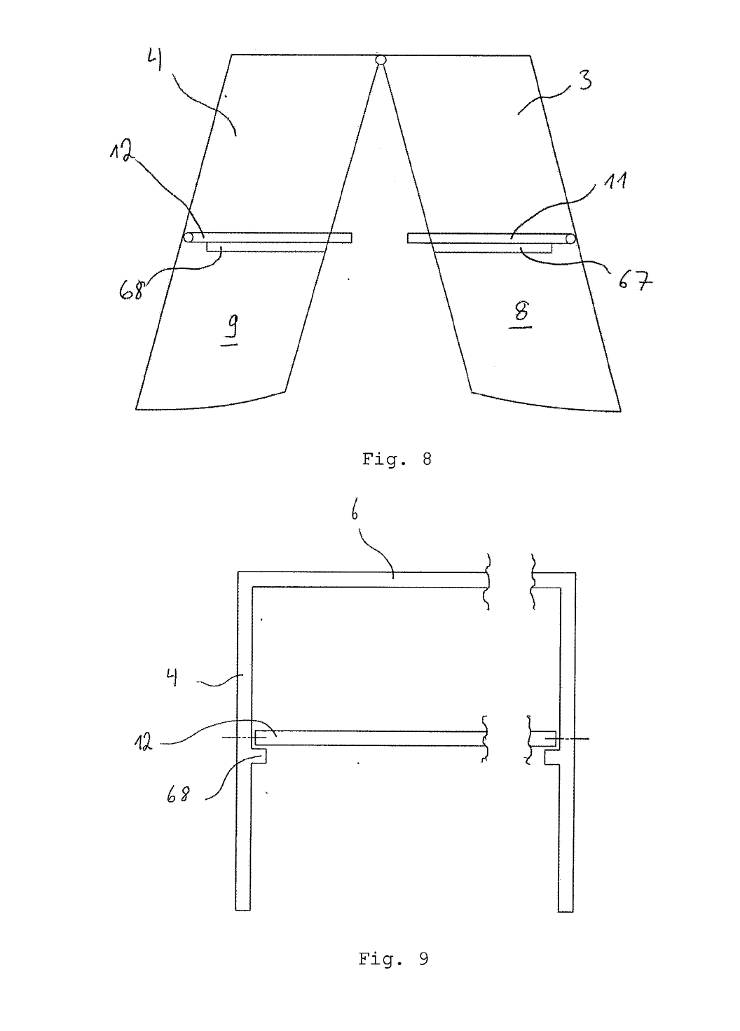

FIG. 7 is a diagrammatic view of the closed step ladder, the struts 61, 62 being attached inside the step ladder and thus concealing the mechanism and preventing external interference. In the collapsed position shown below, the struts 61, 62 further ensure that the folding steps 11, 12 are approximately flush with the surface of the ladder parts 3, 4 and that they are also braced against external pressure. The present embodiment also shows that supports 67, 68 are provided on the inner surfaces of the ladder rails 8, 9 of the ladder parts 3, 4, supporting the opened folding steps 11, 12, shown in detail in FIG. 8, the struts not being shown for the sake of clarity.

FIG. 9 shows the ladder part 4 comprising the step 6 and the folding step 12 resting on the support 68, that is to say, with the ladder being in an opened position.

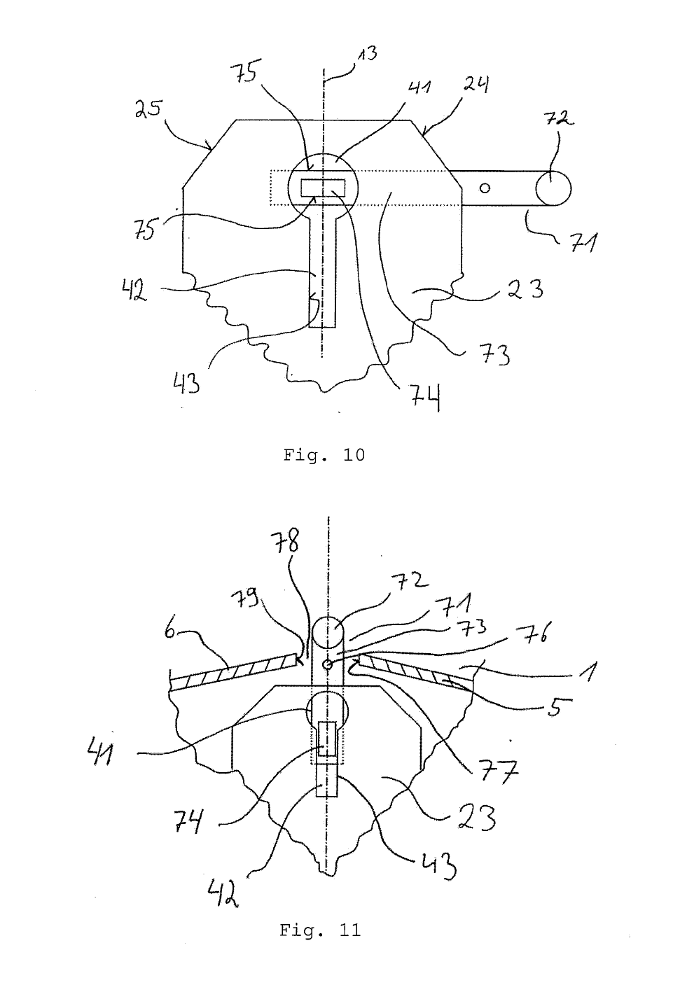

FIGS. 10 and 11 show the manner in which a handle 71 can be mounted on the inner wall 23 for the purpose of making it rotatable and retractable. FIG. 10 shows the handle 71 in an extended position and tilted sideways relatively to the central axis 13. Set in said position is an extension tongue 73 supporting the actual hand piece 72 comprising a lug 74 in the region of the circular recess 41 having a diameter such that the lug 74 may be accommodated in its entire length. The lug 74 comprises guide surfaces 75 interacting with the elongated sliding rail 43 comprising the further recess 42 in a position not shown.

Said position is shown in FIG. 11, the handle 71 comprising the hand piece 72 and the extension tongue 73 slightly protruding beyond the steps 5, 6 after the step ladder 1 has been mounted, that is to say, to such an extent that an opening 76 is still accessible into which a lock (not shown) can be set for the purpose of locking the mounted step ladder against removal of the tool carrier, the inner wall 23 of which is shown. Although the recess 41 with fully extended handle 71 cannot itself prevent tilting of the handle, the handle 71 together with contact areas 77, 78 mounted on the steps 5, 6 is stabilized in the region of an opening 79 of the hinge. In the partly inserted position shown, the hand piece 71 is further secured against tilting in the region of the sliding rail 43 in the recess 42 by means of the guiding cam 74, even when the step ladder 1 is not mounted.

The handle 71 can be wholly countersunk in the tool box formed by the step ladder mounted on the tool carrier, with the result that the upper surface of the hand piece 72 is flush with the steps 5, 6.

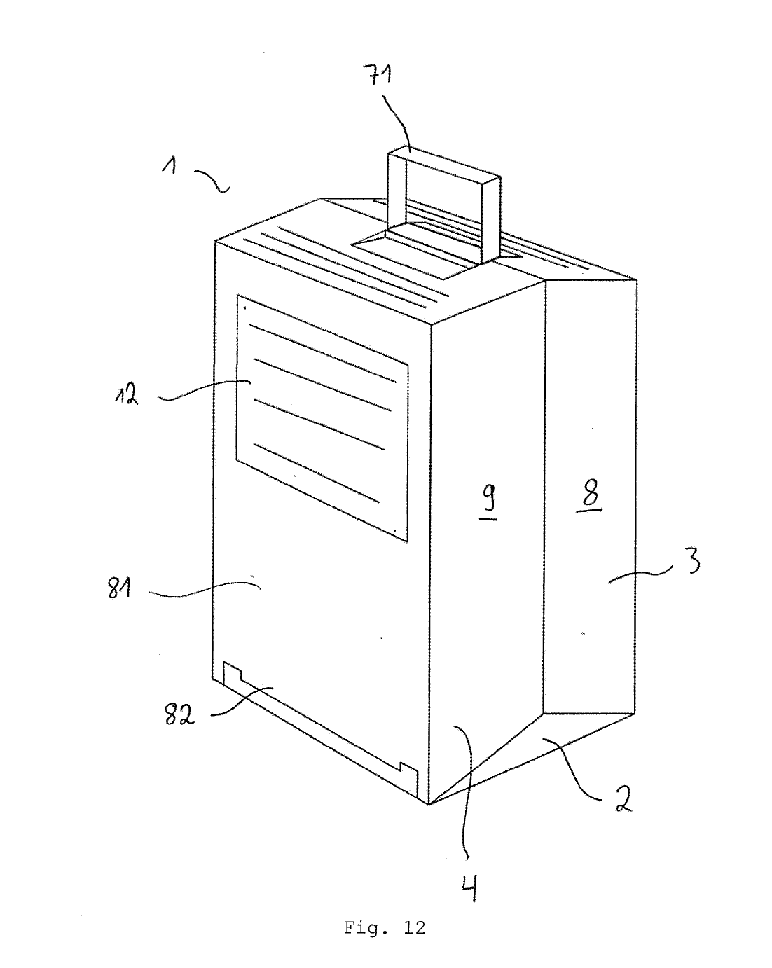

FIG. 12 is a perspective view of the collapsed step ladder 1 mounted on the tool carrier 2 and ready for transportation, the handle 71 being extended. In this position, the folding step 12 is flush with the side wall of the ladder part 4 comprising a closed wall section 81, the two ladder rails 8, 9 being of such widths that they are in contact with each other. The step ladder 1 thus completely encloses the tool carrier 2 above the base 21.

The lowest wall section 82 is partly sunk into the base 2 or, more specifically, is engaged thereby, thus safeguarding said wall section from spreading.

If the tool carrier and the step ladder are being used independently of each other, they can be inter-adjusted for the purpose of achieving an ergonomic working height for the removal of tools from the tool carrier. For the purpose of stabilizing such adjustment, the underside of the tool carrier base may comprise a connecting element allowing for a positive connection with an appropriately designed connecting element on the upper surface of the step ladder, for example a tongue and groove connection in the form of ribs and protrusions.

1. A step ladder comprising a tool carrier, the step ladder comprising two ladder parts comprising a top step, the two ladder parts being foldably interconnected via a hinge in a region of the top step, at least one ladder part comprising a folding step pivotally disposed about a bearing between the lateral uprights of the ladder parts, the folding step being movable in the direction of the upright of the one ladder part when the step ladder is in a collapsed position, and into a position extending toward the other ladder part parallel to the top step when the step ladder is in an opened position, the tool carrier comprising a base and at least one tool carrier wall disposed thereon and extending away from the base, wherein the tool carrier wall is enclosed by the ladder parts, wherein the tool carrier wall comprises at least one of a guide surface and a guide point for the folding step on a side facing away from the base, the at least one of the guide surface and the guide point interacts with the folding step and guides the folding step from the opened position parallel to the top step to the position in the direction of the uprights when the ladder part comprising the folding step is mounted on the tool carrier, wherein a hinged strut possessing high compressive and tensile rigidity is provided on the folding step at a distance from the bearing, rotatably connected to the oppositely disposed ladder part, and a length and bearing points of the hinged strut are dimensioned such that the ladder parts are movable from the opened position to the collapsed position and vice versa by pivoting the folding step.

2. A step ladder according to claim 1, wherein each ladder part comprises a single step.

3. A step ladder according to claim 1, wherein the tool carrier wall is disposed eccentrically on the base comprising the at least one of the guide surface and the guide point and that an inner wall is provided with an inner guide surface or inner guide point disposed more centrally, the inner guide surface or inner guide point being disposed above the guide surface or guide point of the tool carrier wall.

4. A step ladder according to claim 3, wherein the guide surface of the tool carrier wall is disposed at an angle of from approximately 35 to 60 degrees, and the guide surface of the inner wall is disposed at an angle of from approximately 10 to 30 degrees.

5. A step ladder according to claim 1, wherein the ladder part comprises a closed wall section below the folding step and the lateral wall of the ladder part is fully closed in the collapsed position.

6. A step ladder according to claim 1, wherein the tool carrier comprises a handle on the side facing away from the base, the handle being guided longitudinally displaceably along a sliding rail on the at least one of the inner wall and the tool carrier wall and being capable of tilting transversally to the sliding rail in an upper position.

7. A step ladder according to claim 6, wherein the step ladder comprises a recess for the handle in the top step in the region of the hinge, the handle being guarded from tilting by means of contact surfaces on the top step when the step ladder is in a mounted position.

8. A step ladder according to claim 6, wherein in the mounted position of the step ladder, the handle is completely countersunk so as to be flush with the surface of the step.

9. A step ladder in according to claim 1, wherein the base has a groove on at least two oppositely disposed edges for the purpose of receiving and laterally retaining the ladder part by means of a bottom wall section thereof at least partly entering the groove.

10. A step ladder according to claim 1, wherein the ladder part comprising the folding step comprises a support on the inner side of the upright on which the folding step rests in an opened position.

11. A step ladder according to claim 1, wherein the strut is in each case attached to the ladder part below the bearing of the folding step such that the strut assumes an angle of from approximately 5 to 45 degrees, when the step ladder is in the opened position.

12. A step ladder according to claim 11, wherein the strut assumes an angle of from approximately 15 to 20 degrees.
